(19) United States
(12) Patent Application Publication
(10) Pub. No.: US 2020/0367525 A1
(43) Pub. Date: Nov. 26, 2020

(54) METHODS OF PROCESSING UNFERMENTED FRUIT SEEDS SUCH AS COCOA BEANS OR CUPUACU BEANS

(71) Applicant: Mars, Incorporated, McLean, VA (US)

(72) Inventors: Raymond John SCHNELL, II, Miami, FL (US); Edward Stephen SEGUINE, Hanover, PA (US); Cristiano Villela DIAS, Itabuna (BR); Carolina Schaper BIZZOTTO, Itabuna (BR); Jean-Philippe MARELLI, llheus (BR); David Andrew MILLS, Davis, CA (US); Juan Carlos MOTAMAYOR-ARIAS, Miami, FL (US)

(73) Assignee: Mars, Incorporated, McLean, VA (US)

(21) Appl. No.: 16/721,615

(22) Filed: Dec. 19, 2019

Related U.S. Application Data
(63) Continuation of application No. 14/766,787, filed on Aug. 10, 2015, now abandoned.
(60) Provisional application No. 61/767,157, filed on Feb. 20, 2013.
(60) Provisional application No. 61/782,997, filed on Mar. 14, 2013.

(51) Int. Cl. A23G 1/00; A23B 9/26; A23L 25/00

(52) U.S. Cl. CPC A23G 1/002; A23V 2002/00; A23L 25/20; A23B 9/26

(57) ABSTRACT

The present invention provides methods for processing fruit seeds, such as cocoa beans or cupuacu beans without the need of microbial fermentation. Fruit seeds are treated by adding unfermented seeds to a solution of a defined concentration of ethanol in a volume sufficient to cover the seeds, and maintaining the solution at a set temperature for a certain period of time.

### RELATED APPLICATIONS

This application claims the benefit of U.S. Application No. 61/767,157, filed Feb. 20, 2013, and U.S. Application No. 61/782,997, filed Mar. 14, 2013, the contents of which are herein incorporated by reference in their entireties.

### FIELD OF THE INVENTION

The present invention relates generally to methods for processing fresh seeds of fruit, including but not limited to cocoa beans or cupuacu beans suitable for making products such as cocoa and/or cupuacu products without the need of microbial fermentation.

### BACKGROUND OF THE INVENTION

Cocoa beans are the principal raw material for chocolate production. These beans are derived from the fruit pods of the tree Theobroma cacao L., which is cultivated in farms in the equatorial zone, e.g., in Brazil, Costa Rica, Ecuador, Indonesia, Ivory Coast, Ghana and Vietnam. The cocoa beans are surrounded by a mucilaginous pulp inside the pods. Raw cocoa beans have an astringent, unpleasant taste and flavor. Traditionally to obtain the characteristic cocoa flavor and taste, cocoa beans have undergone microbial fermentation by both yeast and bacteria, dried, and roasted.

Chocolate flavor is influenced by the origin of the cocoa beans, the cocoa cultivars or genotypes, the on-the-farm fermentation and drying process, and the roasting and further processing performed by the chocolate manufacturer.

Some suggest that the flavor quality of the fermented cocoa beans is predominantly due to transport kinetics of water and solutes during the fermentation but the full details of this flavor development are poorly understood. Cocoa fermentation process is very heterogeneous and suffers from great variations in both microbial counts and species composition and hence metabolites. The variations seem to depend on many factors including country, farm, pod ripeness, post-harvest pod age and storage, pod diseases, type of cocoa, variations in pulp/bean ratio, the fermentation method, size of the batch, the location of the bean within the batch, season and weather conditions, the turning frequency or no turning, the fermentation time, etc. which makes reproducibility of fermentation particularly difficult. Because the uncontrolled nature of the usual fermentation process, particularly with respect to the lack of control over the growth and development of microorganisms and metabolic production during the process, the quality of the finished cocoa beans and the resultant cocoa products is variable.

A need exists for a method of processing cocoa beans that allows for the characteristic cocoa flavor and taste to develop without the variations of inherent in microbial fermentation. Accordingly, the invention provides a method of processing raw cocoa beans without microbial fermentation that produces cocoa products having the desired cocoa flavor.

### SUMMARY OF THE INVENTION

In various aspects the invention provides a method of processing seeds of fruit, e.g., cocoa beans or cupuacu beans by adding unfermented seeds to a solution of a defined concentration of ethanol in a volume sufficient to cover the seeds, maintaining the solution at a set temperature for a period of time wherein the solution remains substantially free of microbial growth and removing the cocoa beans from the solution to produce processed seeds. The period of time is between 24 to 96 hours. Optionally, the processing is performed under a vacuum or under pressure.

The defined concentration is from about 7% to 16% (v/v). In some embodiments the defined concentration is 7% (v/v) or 12% (v/v). In some embodiments two, three, four or more defined concentration are used sequentially. Alternatively, the defined concentration of ethanol is a continuously variable concentration within a range.

The set temperature is less than 55° C. Preferably, the set temperature is between about 25° C. to 55° C. or between about 45° C. to 51° C. In some embodiments two, three, four or more set temperature are used sequentially. Alternatively, the set temperature is a continuously variable temperature within a range.

In various aspects the fruit seeds are substantially de-pulped prior their addition to the ethanol solution. In other aspects the pulp that has been treated to inhibit endogenous microbial activity is added to the ethanol. The pulp has been mechanically processed. In some embodiments the pulp is derived from the same cultivar as the cocoa beans. Alternatively, the pulp is derived from a cultivar that is different from the fruit seeds.

In further aspects of the invention the fruit seeds have been mechanically or physically processed prior to their addition to the ethanol solution. Mechanically processing includes for example is chopping, bruising or piercing the testa. Physical processing includes for example, a thermal treatment (e.g., heating, chilling or freezing), a microwave treatment, a treatment under water-saturated conditions, an ultrasound treatment, an infra-red treatment, a laser treatment, a pressure treatment, or a vacuum treatment.

In various embodiments the solution is sparged with a gas such as carbon dioxide, nitrogen or argon prior to maintaining at the set temperature.

Optionally, the ethanol solution contains about 0.001 mg to 12 mg citric acid per gram of ethanol solution and/or contains about 1.0 mg to 5 mg acetic acid per gram of ethanol solution.

In some embodiments the methods of the invention further include drying the processed fruit seeds until the total moisture content is about 5 to 10 percent to produce dried fruit seeds. Optionally, the dried fruit seeds are roasted. In further embodiments, the shell is removed from the roasted cocoa beans and the cocoa nibs are recovered. The cocoa nibs are then milled to produce cocoa liquor.

The invention further includes the cocoa beans or cupuacu beans produced according to the methods of the invention and their use in the manufacture of products such as cocoa products and cupuacu products. The invention further provides the food products produced with the cocoa products and cupuacu products of the invention.

Unless otherwise defined, all technical and scientific terms used herein have the same meaning as commonly understood by one of ordinary skill in the art to which this invention pertains. Although methods and materials similar or equivalent to those described herein can be used in the practice of the present invention, suitable methods and materials are described below. All publications, patent applications, patents, and other references mentioned herein are expressly incorporated by reference in their entirety. In cases of conflict, the present specification, including definitions, will control. In addition, the materials, methods, and examples described herein are illustrative only and are not intended to be limiting. Other features and advantages of the invention will be apparent from and encompassed by the following detailed description and claims.

Unless otherwise defined, all technical and scientific terms used herein have the same meaning as commonly understood by one of ordinary skill in the art to which this invention pertains. Although methods and materials similar or equivalent to those described herein can be used in the practice of the present invention, suitable methods and materials are described below. All publications, patent applications, patents, and other references mentioned herein are expressly incorporated by reference in their entirety. In cases of conflict, the present specification, including definitions, will control. In addition, the materials, methods, and examples described herein are illustrative only and are not intended to be limiting. Other features and advantages of the invention will be apparent from and encompassed by the following detailed description and claims.

### BRIEF DESCRIPTION OF THE DRAWINGS

FIG. 1 is an illustration showing the sensory characteristics of cocoa produced by the method of the invention.

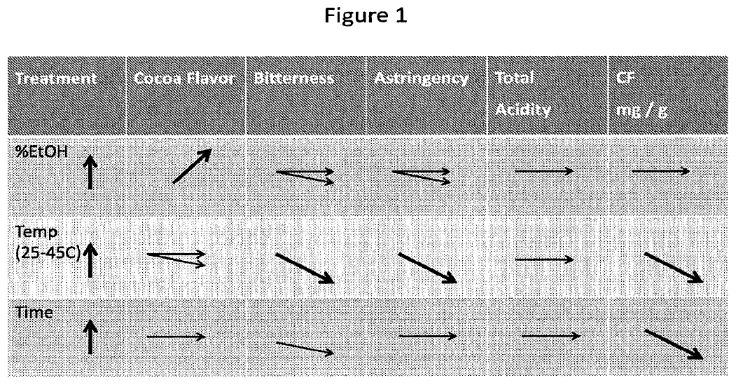

### DETAILED DESCRIPTION OF THE INVENTION

The invention is based on the discovery that microbial fermentation of cocoa beans and/or their pulp is not required to obtain the desired characteristic of cocoa flavor and taste. This is surprising since fermentation is generally accepted in the art as being an important factor in the flavor development of cocoa beans.

Before cocoa can be processed into final products (i.e., cocoa liquor, cocoa powder, cocoa butter) they must undergo post harvesting processing comprising the steps of pod opening, bean removal from the pod, fermentation and drying. In this process, it is well accepted in the art that fermentation constitutes an essential critical step for the development of cocoa flavor. Although the term “cocoa bean fermentation” is widely used, it does not truly designate the fermentation of the cocoa beans themselves but the totality of the activity of microorganisms in the pulp surrounding the beans and the subsequent transformation in the cotyledons to achieve the desired cocoa flavor and taste

Attempts have been made in the prior art to control the post-harvest processing of cocoa beans; however these attempts have focused on controlling the fermentation. To that end, the prior art has attempted to control the fermentation by manipulating either the microrganisms (e.g., yeast and bacteria) and/or the pulp.

For example WO 2007/031186 discloses a method of regulating the fermentation of plant material by adding specific bacterial cultures containing lactic acid bacterium and acetic acid bacterium at different times during the fermentation process.

U.S. Pat. No. 5,342,632 discloses a method for treating cocoa beans for improving fermentation by removing and separating a portion of the pulp from the fresh cocoa beans and fermenting the partly depulped cocoa beans under highly aerobic conditions.

WO 2009/138420 discloses a method of processing cocoa beans by depulping the cocoa beans and treating the pulp and the depulped cocoa beans separately. In particular, the method comprises fermenting the pulp (without the beans) and treating the cocoa beans under at least one acidic condition. After the pulp is fermented and the cocoa beans are acid treated they are combined and the mixture is further processed.

WO 2009/138419 discloses a method of processing cocoa beans by depulping the cocoa beans, fermenting the pulp, combining the pulp with fermented or unfermented cocoa beans and further processing the mixture.

Quesnel (1957) discloses curing cocoa beans in an ethanolic acetic acid solution produced chocolate equivalent in strength of flavor to that of the best Trinidad cocoa. However, Quesnel discloses that acetic acid concentration was the most important factor in curing the cocoa beans in the absence of microbial fermentation and that ethanol had only a mellowing effect on cocoa flavor and increasing the ethanol concentration did not produce a superior product.

In contrast, the present inventors have shown that beans soaked in ethanol alone at the proper temperature could produce cocoa with acceptable taste and quality.

Accordingly, the invention provides a method of processing cocoa beans for the production of cocoa products without the need for microbial (i.e. yeast and bacterial) fermentation. The invention provides a method of processing cocoa beans into cocoa products having a desired flavor and organoleptic properties. The invention provides high-flavored cocoa beans by means of a simple, faster, more controllable (i.e., less variable) and reproducible process, resulting in a cocoa product having a controllable, well-defined, and repeatable flavor and taste profile.

One skilled in the art would readily recognize that the methods disclosed herein may be used to process other seeds of fruit that require fermentation such as Theobroma grandiflorum (cupuaçu), or tomato seeds

In the present invention, the tree material is preferably derived from any species of the genera Theobroma or Herrania or inter- and intra-species crosses thereof within those genera, and more preferably from the species Theobroma cacao and Theobroma grandiflorum. The species Theobroma cacao as used herein comprises all genotypes, particularly all commercially useful genotypes, including but not limited to Criollo, Forastero, Trinitario, Arriba, Amelonado, Contamana, Curaray, Guiana, Iquitos, Maranon, Nacional, Nanay and Purus, and crosses and hybrids thereof. Cocoa beans derived from the fruit pods of Theobroma cacao are the principal raw material for chocolate production. The cocoa beans are surrounded by a mucilaginous pulp inside the pods. After the pods are harvested, the cocoa beans (usually including at least a portion of the surrounding pulp) are recovered from the pods. Accordingly, the tree material used in the method of the invention may preferably comprise cocoa beans derived from the fruit pods of Theobroma cacao, and may further comprise the pulp derived from the fruit pods. In an embodiment, the tree material may consist essentially of cocoa beans and the pulp derived from the fruit pods of Theobroma cacao.

The terms “cocoa” and “cacao” as used herein are considered as synonyms.

The term “fermentation” refers generally to any activity or process involving enzymatic or metabolic decomposition (digestion) of organic materials by microorganisms. The term “fermentation” encompasses both anaerobic and aerobic processes, as well as processes involving a combination or succession of one or more anaerobic and/or aerobic stages. “Anaerobic” fermentation is meant that the conditions are such the decomposition of organic matter by microorganisms that prefer anaerobic conditions are favored over the decomposition of organic matter by microorganisms that prefer aerobic conditions. Likewise, “aerobic” fermentation is meant that the conditions are such the decomposition of organic matter by microorganisms that prefer aerobic conditions are favored over the decomposition of organic matter by microorganisms that prefer anaerobic conditions.

The term “fruit seed” or “seed of fruit” as used herein is intended to refer to the propagative part of a plant. A fruit seed can be, for example, a cocoa bean, a cupuacu bean, a tomato seed or a coffee bean.

The term “cocoa beans” as used herein is intended to refer to cocoa beans or cocoa seeds as such as well as parts thereof. Cocoa beans basically consist of three parts: an outer part comprising the testa or seed coat surrounding the bean; an inner part comprising the cotyledons and the embryo or germ contained within the testa; and the pulp. The bean when broken is referred to as “cocoa nibs”. In the present specification, the terms “testa” or “shell” or “seed coat” are used as synonyms.

The term “cupuacu bean” as used herein is intended to refer to cupuacu beans or cupuacu seeds as such as well as parts thereof.

The term “pulp” in accordance with the present invention relates to the mucilaginous plant material in which cocoa beans are embedded inside the cocoa pods.

The term “fermented cocoa beans” is intended to refer to cocoa beans that have been fermented either deliberately or adventitiously for at least one day, preferably at least two days, thus, that have undergone a fermentation process.

The term “unfermented cocoa beans” is intended to refer to cocoa beans that have been liberated from cocoa pods and have not yet been fermented. Unfermented cocoa beans generally are not yet germinated.

As used herein the term “non-depulped” cocoa beans refer to cocoa beans that have not been liberated from their pulp. The term “depulped” cocoa beans refers to cocoa beans that have been essentially liberated from their pulp. “Essentially liberated” refers to the removal from the cocoa beans of more than 40%, preferably more than 50, 65, 70, 75, 80, 85, 90, 95, 97, or 99% by weight of pulp based upon the original total combined weight of beans and pulp. The process according to the invention can use non-depulped cocoa beans, depulped cocoa beans or partially de-pulped cocoa beans.

A “spontaneous fermentation” or “natural fermentation” or “fermentation process” as used herein is one that employs endogenous microorganisms naturally present in and/or unconsciously introduced into the organic material at the start or during the fermentation. By means of example and not limitation, in spontaneous fermentation of cocoa beans and pulp, microorganisms may be introduced after the beans and the pulp are released from the pods from natural microbiota present, for example, on workers' hands, tools (knifes, shovels, unwashed baskets, etc.), in the air where the pods are being broken open, the fermentation box or basket, coverings such as banana leaves, jute or other sacks and in places of previous fermentations. Additionally, prior to the addition of ethanol, endogenous yeast and bacteria naturally present in the organic material may be inhibited by the addition of microbial growth inhibitors such as sulfites.

The term “food product” is used herein in a broad sense, and covers food for humans as well as food for animals (i.e. a feed). In a preferred aspect, the food is for human consumption.

The term “about” or “approximately” as used herein when referring to a measurable value such as a parameter, an amount, a temporal duration, and the like, is meant to encompass variations of +/−20% or less, preferably +/−10% or less, more preferably +/−5% or less, and still more preferably +/−1% or less of and from the specified value, insofar such variations are appropriate to perform in the disclosed invention. It is to be understood that the value to which the modifier “about” or “approximately” refers is itself also specifically, and preferably, disclosed.

The term “significant” as used herein when referring to a measurable value such as a parameter, an amount, and the like. In some aspects significant is meant to encompass variations of +/−20%, preferably +/−10%, or +/−5% or less, insofar such variations are appropriate to perform in the disclosed invention.

The terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

By “bulk quantity” it is meant greater than 600 grams of cocoa beans. Preferably, a bulk quantity is at least 1 kg, 2 kg, 5 kg or more.

The term “sensory characteristic” refers to an organoleptic sensation comprising one or all of the following characteristics: the sensations associated with recognized mouth taste sensations associated with in-mouth receptors(sweet, sour/acid, salty, bitter, umami, fatty); the sensations associated with the retronasal characterization of volatile elements of flavor (fruit, floral, etc.); and other mouth sensations not necessarily associated with specific receptors (astringency, creamy, gritty).

In a preferred embodiment, said “sensory characteristic” is a “taste characteristic”, which can be used interchangeably with “flavor characteristic”.

All these terms relate to gustation (i.e.tasting) of cocoa beans or derived products therefrom. In general, overall taste is composed of different taste characteristics. By means of example, and without limitation, in the context of cocoa or derived products therefrom, the following sensory characteristics, such as taste characteristics, can be discerned: astringent, bitter, sour, acidity, fruity, flowery, total intensity, aftertaste intensity, aftertaste time, cocoa taste, chocolate taste, aromatic, winey, putrid, carbon, and grilled, as well as off-note flavors including baggy, smoky, mouldy, earthy, raw, hammy, metallic, rancid, burnt and musty. These sensory characteristics are all well known in the art, and the most important ones are briefly described for further guidance.

“Astringent” can be defined as the chemical feeling factor perceived on the tongue and other oral surfaces, described as puckering or drying, elicited with tannins or alum. Astringency is associated with the action of polyphenols and peptide materials. Cocoa material which is astringent may be perceived as less desirable by certain consumer groups.

“Cocoa” can be defined as the basic cocoa note, which is characteristic of well fermented, de-shelled, roasted, and ground cocoa beans especially characteristic of specific types or genotypes (eg: Amelonado, Comum, or West African types).

“Bitter” can be defined as one of the four basic tastes perceived most sensitively at the back of the tongue, stimulated by solutions of caffeine, quinine, and other alkaloids.

“Acid” or “Sour” can be defined as one of the four basic tastes perceived on the tongue, associated with acids like citric acid.

“Total intensity” can be defined as a full-flavor intensity contrasting with watery. It indicates the “overall” or total flavor intensity of the product.

“Bouquet” is a general term covering all flavor elements over and above the cocoa character, e.g. aromatic, floral, and fruity notes.

The present method encompasses the processing of cocoa beans by harvesting cocoa beans from cocoa pods; soaking the cocoa beans in a solution of ethanol at a set temperature for a predetermined period of time; and removing the cocoa beans from the solution. The ethanol solution is also referred to herein as the soak solution. The processed cocoa beans are then subjected to conventional drying, roasting and milling processes to produce cocoa products.

The ethanol concentration is defined. By defined concentration is meant that the ethanol concentration of the soak solution is set at the onset of the method. More specifically, by defined concentration it is meant that the ethanol concentration of the soak solution does not substantially increase during the method of the invention. In other words, no significant endogenous ethanol is produced, unlike during traditional cocoa processing in which anaerobic yeast fermentation occurs which produces ethanol as a by-product. The skilled artisan will appreciate that the ethanol concentration in the soak solution may decrease slightly as the water in the cocoa beans is displaced by the ethanol soak solution until equilibrium is reached. The defined concentration can be at least 1%, 2%, 3%, 4%, 5%, 6%, 7%, 8%, 9%, 10%, 11%, 12%, 13%, 14%, 15%, 16%, 17%, 18%, 19%, 20%, 25%, 30%, 40%, 50%, 60%, 70%, 80%, 90%, or more (v/v). Preferably, the defined concentration of ethanol is a concentration high enough to prevent spontaneous fermentation by endogenous microbes. For example, the define concentration of ethanol is at least 1% , 2%, 3%, 4%, 5%, 6%, 7%, (v/v) or more. In some embodiments the concentration is between 1% to about 50% (v/v), 1% to about 25% (v/v), 1% to about 20% (v/v), 1% to about 15% (v/v), 2% to about 50%, (v/v), 2% to about 25% (v/v), 2% to about 20% (v/v), 2% to about 15% (v/v); 3% to about 50% (v/v), 3% to about 25% (v/v), 3% to about 20% (v/v), 3% to about 15% (v/v), 4% to about 50% (v/v), 4% to about 25% (v/v), 4% to about 20% (v/v), 4% to about 15% (v/v), 5% to about 50% (v/v), 5% to about 25% (v/v), 5% to about 20% (v/v), 5% to about 15% (v/v), 6% to about 50% (v/v), 6% to about 25% (v/v), 6% to about 20% (v/v), 6% to about 15% (v/v), 7% to about 50% (v/v), 7% to about 25% (v/v), 7% to about 20% (v/v), 7% to about 15% (v/v). Preferably, the defined concentration is between about 7% to about 16% (v/v). More preferably the defined concentration is between about 7% to about 12% (v/v). Most preferably the defined concentration is about 7%, about 10%, about 12%, about 13% or about 16% (v/v). The amount of ethanol will vary depending upon the amount of cocoa beans to be processed. All that is minimally required is that a sufficient quantity of the ethanol solution is used to completely cover (i.e., submerge) the cocoa beans at the commencement of the method. However, one skilled in the art will recognize that more ethanol solution that what is required to cover the beans can be used.

In some aspects of the method of the invention uses one or more defined concentrations of ethanol. For example, the beans are soaked in first defined concentration of ethanol for a predetermined period of time and temperature and then transferred to a second defined concentration of ethanol for a predetermined period of time and temperature.

In other aspects the, the defined concentration of ethanol a defined range of concentrations. For example, the defined concentration of ethanol is a continuously variable concentration within a defined range. The defined range is for example between 1% and 90% (v/v); 1% and 80% (v/v); 1% and 70% (v/v); 1% and 60% (v/v); 1% and 50% (v/v); 1% and 40% (v/v); 1% and 30% (v/v); 1% and 20% (v/v); 1% and 16% (v/v); 1% and 12% (v/v); or 1% and 7% (v/v).

The cocoa beans in the ethanol solution are maintained at set temperature. By “set temperature”, it is meant that the temperature does not vary. The skilled artisan will appreciate that slight fluctuations in temperature will occur due to standard error of the temperature monitoring and maintenance devices. Thus, by set temperature it is meant that the temperature does not vary outside the accepted tolerances of the temperature and maintenance devices used to practice the claimed methods. A set temperature is less than 60° C. Preferably, the set temperature is less than 55° C. The set temperature is between 20° C. to 55° C. More preferably, the set temperature is between 25° C. to 55° C. Even more preferably, the set temperature is between 45° C. to 51° C. For example, the set temperature is about 20° C., 21° C., 22° C., 23° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., or 59° C.

In some aspects of the method of the invention uses one or more set temperatures. For example, the beans are maintained in the soak solution for a predetermined amount of time for a first set temperature and then maintained at a second set temperature for a second predetermined period of time. Two, three, four, five or more set temperatures may be used in the methods of the invention.

In other aspects the set temperature is a defined range of temperatures. For example, the set temperature is a continuously variable temperature within a defined range. The defined range is for example between 20° C. to 55° C.; 20° C. to 51° C.; 20° C. to 45° C.

The cocoa beans in the ethanol solution are soaked for a period of time. The period of time is also referred to herein as the soak period or soak time. The soak period may vary depending upon the cocoa cultivar being processed. In some embodiments, the soak time is the time that is required for cocoa bean death to occur. By cocoa bean death is meant that the germination of cocoa beans has been inhibited. The term “germination of cocoa beans (cocoa seeds)” as used herein refers to the sprouting of a cocoa seedling from a cocoa seed. “Inhibition” of germination as used in the present application is intended to refer to the effect of avoiding that germination of the cocoa seeds starts but also to the effect of ending (interrupting) germination of the cocoa seeds if germination is or has been already started. Germination of at least 30%, 40%, 50%, 60% 70% 80%, and preferably at least 85%, 90%, 95%, and even up to 100% of the cocoa beans is inhibited. Inhibition of germination can be measured by determining a germination rate by means of a germination assay. The germination rate is the number of cocoa seeds that germinate under proper conditions, and in particular, that germinate when growing the cocoa seeds on earth or cotton for 7 days at 25-31° C. under humidity saturated conditions. The germination rate is expressed as a percentage, e.g. 15% germination rate indicates that about 15 out of 100 seeds germinate.

In alternative embodiments, the soak period is the time that is required for the concentration of ethanol within the bean to reach equilibrium with the concentration of ethanol of the soak solution. Preferably, the period of time is between 24-168 hours.

During the soak period, the ethanol solution is substantially free of microbial growth (e.g. bacterial or yeast). In other words, spontaneous fermentation of the pulp if present (i.e., anaerobic or aerobic) does not substantially occur. Microbial growth is determined by known methods.

During the soak period, it may be desirable to mix, agitate, turn, or stir the beans in the container. This may be achieved manually or mechanically. In some embodiments the cocoa beans are mixed, agitated, turned, or stirred continuously or at regular intervals. For example, the cocoa beans are mixed, agitated, turned, or stirred at over about 24 hours, about 48 hours, about 72 hours, about 96 hours after the initiation of the soak period.

In some embodiments the cocoa beans include the pulp or portion thereof. Alternatively, the cocoa beans are substantially depulped. The pulp is derived from the same cultivar as the cocoa beans. Alternatively, the pulp is derived from a different cultivar than the cocoa beans.

When including the pulp or portion thereof, the pulp may be separated from the cocoa beans. Optionally, the pulp may be mechanically processed prior to the addition to the ethanol solution. For example, the pulp may be mashed or blended.

The pulp may be fermented prior to the addition to the ethanol solution. Alternatively, the pulp is not fermented prior to the addition to the ethanol solution. In some aspects when fermentation of the pulp is not desired or to stop fermentation, the pulp (non-fermented or fermented) may be pre-treated prior to addition to the ethanol solution to insure that all endogenous microbial activity is inhibited. For example, the pulp may be treated with a sulfite solution or similar food grade antimicrobials. Pre-treatment of the pulp is particularly important when the concentration of the ethanol soaking solution is low enough to allow spontaneous microbial activity.

In another embodiment, at least a part of the cocoa beans are dried or pre-dried before the actual process. This operation may be or may not be preceded by a reduction of pulp as described above. The pre-drying step may be carried out in any conventional hot air dryer, such as a circular drier, or using any alternative drying system such as sun drying. The cocoa beans are dried until the total moisture content is between 25-50%.

Various pre-treatments (mechanical and physical) and combinations thereof may be applied in accordance with the present invention.

Mechanical treatments include for example, depulping, scoring, scraping, chopping, cracking, crushing, pressing, bruising, rubbing, centrifugation, piercing, cutting or perforation of the cocoa beans and any combinations thereof.

Mechanical treatment facilitates the transport of fluids and gases from the interior of the seed across shell to the exterior environment. In particular, mechanical treatment allows for aeration of cocoa beans and of cocoa cotyledons.

As used herein, “pierce” generally refers to forming an opening in a cocoa bean, while leaving the portion of the cocoa bean surrounding the opening substantially intact. “Intact” generally refers to unitary or whole. A pierced cocoa bean may be a perforated cocoa bean. A “perforated” cocoa bean refers to a cocoa bean pierced in one, two or more locations to form openings. The openings may be substantially uniform in size and/or shape. Cocoa bean may be pierced in a variety of methods, such as piercing with a solid object, piercing with a fluid jet, piercing with droplets of enzymes or acids, piercing with electromagnetic radiation, or combinations thereof.

Physical treatments include for example, a thermal treatment (e.g. heating, chilling or freezing), a microwave treatment, a treatment under water-saturated conditions, an ultrasound treatment, an infra-red treatment, a laser treatment, a pressure treatment, a vacuum treatment and any combinations thereof.

In alternative embodiments, no pre-treatment to the cocoa beans are applied. In some embodiments the cocoa beans used in the method according to the invention are intact cocoa beans at the beginning of the soak period. Specifically, in some embodiments of the invention the cocoa beans are not pierced.

In some embodiments the ethanol solution contains additive(s). Additives include for example, acids such as citric acid, acetic acid, or phosphoric acid; enzymes such pectinase; microbial growth inhibitors; preservatives; or an aromatic or tastant substance.

Preferably, additive(s) is/are added to the cocoa beans at the beginning of the soak period or up to 24 hrs after the start of the incubation period. In one embodiment, additives(s) is/are added to the cocoa beans up to 24 hrs, or up to 36 hrs, or up to 48 hrs, up to 72 hrs, or up to 96 hrs after the start of the soak period.

Citric acid when used is added to the ethanol solution at a concentration between 0.001 mg to 25 mg of citric acid per gram of ethanol solution. Preferably, the concentration is between 0.001 mg to 12 mg of citric acid per gram of ethanol solution Acetic acid when used is at a concentration between 1 mg to 5 mg of acidic acid per gram of ethanol solution. Preferably the concentration is 1.5 mg acetic acid per gram of ethanol solution. When acids are used during the methods of the invention, optionally they may be neutralized during the process.

Aromatic or tastant substances (e.g. salts, spices, aromatic wood and synthetic aromatic substances) may be any natural, natural identical or artificial aromatic substance or tastant substance used in the food industry and elsewhere. This includes substances that can be smelled and/or tasted. Generally, the aromatic substance or tastant are capable of modifying the flavor and/or aroma of the cocoa beans during the fermentation process.

Preferred solid or aqueous aromatic or tastant substances are fruit pulps, aromatic leaves, roots, flowers, stems, wooden parts, such as pieces of aromatic timber, any kind of powders (such as ground aromatic powders, herbs or spices.

Preferred liquid aromatic or tastant substances are oils such as essential oils and juices (e.g., fruit juices) made of a plant or made of fruit pulp.

In one embodiment, at least one aromatic or tastant substance as listed in the European “Register of flavoring substances notified by the Member States pursuant to Article 3(1) of Regulation ECNo 2232/96 of the European Parliament and of the Council of 28 Oct. 1996 laying down a Community procedure for flavoring substances used or intended for use in or on foodstuffs”, in the version published in the Official Journal of the European Communities, L 84, Volume 42, dated 27 Mar. 1999, is used. The content of said Register (in particular the names of the flavoring substances and the respective CAS numbers insofar these had been attributed or made available) is herewith incorporated by reference in its entirety.

In certain embodiments, the aromatic or tastant substance is a salt such as acetic or lactic salt.

In certain embodiments, the aromatic or tastant substance is a clutching agent such as sodium carbonate, sodium bicarbonate, ammonium hydroxide. When alkai are used during the methods of the invention, optionally they may be neutralized during the process.

Other aromatic substances suitable for use in the present invention include for example those disclosed in WO 2009/103137, the contents of which are incorporated by reference in its entirety.

In some embodiments, after the cocoa beans are placed in the ethanol solution, the solution is sparged with a gas before the incubation period. The gas is for example carbon dioxide, or any inert gas such as argon or nitrogen. Optionally, incubation of the cocoa beans and the ethanol solution is done under a vacuum or under pressure.

After the incubation period, the cocoa beans are removed from the ethanol solution and the cocoa beans are dried until the total moisture content is less that 10 percent, preferably the cocoa beans are dried to about 7 to 8 percent moisture. Once dried to the appropriate moisture content, the cocoa beans may be aged. Aging allows for the elimination of some flavor artifacts. For example, the cocoa beans are aged for 2, 3, 4, 5, 6, 7, 8, 9, 10 or more weeks, preferably at least 6 weeks, at room temperature, prior to liquor making. Some varieties may age faster, some may age a bit slower, but in general the 6 week aging is a good balance point between undue aging time and eliminating some flavor artifacts.

After the cocoa beans are dried and optionally aged, the beans are roasted and milled to liquor using procedures well known in the art, including roasting the beans; removing the shell and milling the recovered cocoa nibs into cocoa liquor. The cocoa liquor obtained from cocoa beans processed by the methods of the invention have sensory characteristics substantially the same as cocoa liquor produced by traditionally fermented cocoa beans. By sensory characteristics substantially the same as cocoa liquor produced by traditionally fermented cocoa beans, is meant that an individual trained in chocolate sensorial analysis and familiar with the flavor of beans from cocoa trees of various genotypes fermented via traditional fermentation processes will recognize that the sensory characteristics obtained by the method of the invention produces sensory characteristics of what experts would expect over a large number of commercial fermentations of beans from these genotypes.

According to the invention, sensory characteristics, such as taste characteristics of all cocoa-derived material, in addition to cocoa liquor can be evaluated. Accordingly, in an embodiment, sensory characteristics are scored for cocoa-derived material such as cocoa beans, cocoa powder, cocoa butter, cocoa nibs, cocoa pulp, cocoa flakes, cocoa extract, cocoa mass, cocoa cake, and chocolate. As cocoa liquor represents a homogenous cocoa derivative, sensory characteristics may advantageously and preferably be evaluated for cocoa liquor.

Sensory characteristics such as taste characteristics are usually evaluated by means of a taste panel. Taste panels can be consumer taste panels or expert or trained taste panels. Preferably, the taste panel is an expert or trained taste panel, in which all members thereof are familiar with the protocols and taste characteristics, which allow for a more objective evaluation of the taste characteristics. Taste panels are well known in the art. In essence, each member of the taste panel scores one or more taste characteristics, preferably on a numerical scale. Scores typically vary between a minimum score, corresponding to the (substantial) absence of the taste characteristic, and a maximum score, corresponding to a very strong or dominant presence of the taste characteristic. A number of intermediate scores between the minimum and maximum score are typically also presented. It is to be understood that references herein to a comparison of sensory or taste characteristics essentially relate to a comparison of the score of such sensory or taste characteristic. In some embodiments the scores of the cocoa products produced by the methods of the invention are substantially similar to the scores of the cocoa products produced by traditional fermentation. As used herein, the terms “substantially similar” preferentially refer to scores which differ by no more than 20%, preferably no more than 15%, more preferably no more than 10%, even more preferably no more than 5%.

The cocoa liquor obtained for cocoa beans processed by the method of the invention have sensory characteristics of cocoa liquor that are within the range of what an individual trained in chocolate sensorial analysis would expect from cocoa liquor produced by traditionally fermented cocoa beans.

In some embodiments the cocoa liquor obtained for cocoa beans processed by the method of the invention are superior to the sensory characteristics of cocoa liquor produced by traditionally fermented cocoa beans. By superior it is meant that an individual trained in chocolate sensorial analysis determined that the quality of the cocoa liquor obtained by the method of the invention is higher in at least one or more cocoa flavor attributes than the chocolate liquor obtained by traditional fermentation. Preferably, quality of the cocoa liquor obtained by the method of the invention is higher in two, three, four, five or more cocoa flavor attributes than the chocolate liquor obtained by traditional fermentation.

Each sample can be evaluated for, including but not limited to, one or more of the following flavor attributes: “cocoa flavor” (as found in Ghanaian beans), “acidity” (qualifies the basic taste generated by dilute aqueous solutions of most acids), “bitterness” (qualifies the basic taste generated by dilute solutions of various substances such as caffine, perceived on the top of the tongue and at the back of the palate), “fruity” (taste note belonging to the bouquet and which evokes a fruit which has reached maturity: apple, banana, pear and the like), “flowery”, e.g., “total floral” or “floral woody”(corresponds to an olfactory sensation evoking flowers in general: rose, jasmin, hyacinth, lilac and the like), “nutty, nut skins, and caramel notes” (the taste and odor of roasted nuts, nut skins, and caramelized sugars) “smoky” (taste and odor of smoke; defect resulting in general from drying the cocoa beans after fermentation by means of a wood fire), “hammy” (taste and odor of smoked ham or other smoked meat; defect resulting in general from diseased cocoa beans, “musty” (taste and odor of damp slightly moldy materials), and “raw” (feature of insufficiently roasted cocoas where the flavor has not developed); “earthy” (corresponds to an olfactory sensation that evokes fresh clean slightly damp earth or potting soil or the rich smell of the earth in a forest after a light rain). “bark woody”, “dirty”, etc. In addition, each sample can be evaluated for other sensations, including but not limited to, “astringency” (corresponds to sensations of a physical nature, from the suppression of unctuousness to the astringency in the medical sense which covers constriction and/or crispation of the tissues) or “other” (a compilation of flavors otherwise specified in the aforelisted attributes). “Other off” flavors as used herein refer to flavors such as cardboardy, stale, baggy, tar-like, burnt rubber, etc., flavors that would be considered to be “off flavors” that are known to a skilled person in the art and have not been aforementioned.

In addition to the sensory characteristics, the cocoa beans processed according to the methods of the invention, or the cocoa products produced therefrom, also have nutritional and chemical characteristics that are substantially similar or superior to cocoa beans that have been traditionally fermented. Nutritional and chemical characteristics include for example, fat, moisture, crude protein, theobromine, caffeine, sugars, starch, total dietary fiber, organic acids, ash, cholesterol, minerals (such as, without limitation, potassium, sodium, calcium, magnesium, phosphorus, chloride, iron, zinc, copper) or vitamins (such as, without limitation, A (retinol), B1 (thiamine), B2 (riboflavin), B3 (niacin), Vitamin B5, C (ascorbic acid), E (tocopherol)). The chemical composition equally relates to for instance fatty acid composition (such as percentages of saturated, monounsaturated or polyunsaturated fatty acids) and type (such as percentages of for instance palmitic (C16:0), stearic (C18:0), oleic (C18: 1), palmitoleic (C16: 1), linoleic (C18:2), arachidic (C20:0) orother fatty acids). Methods for determining these parameters are well known in the art (see for instance “de Zaan Cocoa & Chocolate Manual”, 2009, ADM Cocoa International, Switzerland).

In yet another aspect, the invention relates to cocoa beans that are obtained or obtainable by a carrying out a method according to the invention. Specifically, the invention also relates to cocoa products prepared with one or more cocoa beans as defined herein. “Cocoa products” according to the present invention are defined as products that can be prepared using cocoa beans, and such as cocoa powder, cocoa extract, cocoa liquor, cocoa mass, cocoa cake, and cocoa butter. Cocoa products can be in a liquid form or in a dry or lyophilized form, such as in the form of granules, pellets, or a powder.

The invention thus relates to the use of cocoa beans according to the invention for the preparation of food products, e.g. preferably chocolate products, and to food products thereby obtained. For this, cocoa beans according to the invention can be conventionally processed into cocoa products such as cocoa butter, cocoa powder, cocoa liquor, cocoa mass, and further introduced in food products.

The food may be in the form of a liquid or as a solid. Non limitative examples of food products which may be obtained using cocoa beans according to the present invention include for instance chocolate products, chocolate drinks, nutritional beverages, beverage powders, milk-based products, ice cream, confectionery, bakery products such as cakes and cake mixes, fillings, cake glaze, chocolate bakery filling, doughnuts, chocolate syrup, chocolate sauce, and dairy products.

Food products, e.g. chocolate products, comprising cocoa beans or cocoa products derived thereof as defined herein may have improved characteristics, including for instance improved storage stability, improved organoleptic properties such as for instance a better flavor profile, better flavor release, prolonged flavor retention and improved appearance, than equivalent products made from cocoa beans that have been traditionally fermented.

### EXAMPLE 1

### Evaluation of Ethanol Concentration, Soak Time and Temperature on the Development of Cocoa Flavor

In order to determine if cocoa beans could develop a cocoa flavor without microbial fermentation, cocoa beans from a single variety, PS 1319 (a variety commonly grown in Bahia, Brazil) were soaked in either a 7% (v/v) or 12% (v/v) solution. For each concentration of ethanol three temperatures were evaluated 25° C., 4° C., and 60° C. Approximately 100 g of de-pulped cocoa beans were used per treatment. A sufficient amount of ethanol was used to completely cover the beans. Each treatment was performed in triplicate. Laboratory scale fermentation (MI) was used as a control.

Samples were collected at 0, 12, 24, 36, 48 and 168 hours and the beans were processed into cocoa liquor and assessed for flavor. The Table below summarizes the flavor profile of the chocolate liquor produced as tasted by a professional taster in a double blind taste test.

| | Ethanol | | | | Total ETOH | | |
|---|---|---|---|---|---|---|---|
| Sample | ETOH Conc. | Temp | Time | Cocoa | Acidity | Bitterness | Astringency |
| ETOH_12% (25).72 | 12% ETOH | 25° C. | 72 | 4 | 1 | 7 | 9 |
| ETOH_12% (25).72 | 12% ETOH | 25° C. | 72 | 5 | 0 | 8 | 7 |
| ETOH_12% (25).72 | 12% ETOH | 25° C. | 72 | 5 | 0 | 6 | 8 |
| ETOH_12% (25).72 | 12% ETOH | 25° C. | 72 | 5 | 0 | 7 | 8 |
| ETOH_12% (25).72 | 12% ETOH | 25° C. | 72 | 5 | 0 | 6 | 8 |
| ETOH_12% (25).72 | 12% ETOH | 25° C. | 72 | 6 | 0 | 7 | 8 |
| ETOH_12% (25).72 | 12% ETOH | 25° C. | 72 | 4 | 2 | 7 | 9 |
| ETOH_12% (25).72 | 12% ETOH | 25° C. | 72 | 5 | 1 | 6 | 8 |
| ETOH_12% (25).72 | 12% ETOH | 25° C. | 72 | 6 | 0 | 6 | 8 |
| ETOH_12% (25).168 | 12% ETOH | 25° C. | 168 | 6 | 0 | 6 | 7 |
| ETOH_12% (25).168 | 12% ETOH | 25° C. | 168 | 8 | 0 | 4 | 5 |
| ETOH_12% (25).168 | 12% ETOH | 25° C. | 168 | 8 | 0 | 5 | 6 |
| ETOH_12% (25).168 | 12% ETOH | 25° C. | 168 | 5 | 0 | 7 | 8 |
| ETOH_12% (25).168 | 12% ETOH | 25° C. | 168 | 6 | 0 | 6 | 7 |
| ETOH_12% (25).168 | 12% ETOH | 25° C. | 168 | 6 | 0 | 6 | 10 |
| ETOH_12% (25).168 | 12% ETOH | 25° C. | 168 | 6 | 0 | 7 | 9 |
| ETOH_12% (25).168 | 12% ETOH | 25° C. | 168 | 7 | 0 | 7 | 7 |
| ETOH_12% (25).168 | 12% ETOH | 25° C. | 168 | 7 | 0 | 6 | 7 |
| ETOH_12% (45).72 | 12% ETOH | 45° C. | 72 | 4 | 0 | 7 | 9 |
| ETOH_12% (45).72 | 12% ETOH | 45° C. | 72 | 6 | 0 | 6 | 8 |
| ETOH_12% (45).72 | 12% ETOH | 45° C. | 72 | 7 | 0 | 7 | 8 |
| ETOH_12% (45).72 | 12% ETOH | 45° C. | 72 | 4 | 2 | 5 | 8 |
| ETOH_12% (45).72 | 12% ETOH | 45° C. | 72 | 6 | 0 | 6 | 8 |
| ETOH_12% (45).72 | 12% ETOH | 45° C. | 72 | 6 | 0 | 5 | 6 |
| ETOH_12% (45).72 | 12% ETOH | 45° C. | 72 | 4 | 0 | 7 | 9 |
| ETOH_12% (45).72 | 12% ETOH | 45° C. | 72 | 5 | 0 | 6 | 7 |
| ETOH_12% (45).72 | 12% ETOH | 45° C. | 72 | 6 | 0 | 7 | 8 |
| ETOH_12% (45).168 | 12% ETOH | 45° C. | 168 | 6 | 0 | 6 | 7 |
| ETOH_12% (45).168 | 12% ETOH | 45° C. | 168 | 6 | 1 | 5 | 7 |
| ETOH_12% (45).168 | 12% ETOH | 45° C. | 168 | 7 | 0 | 5 | 6 |
| ETOH_12% (45).168 | 12% ETOH | 45° C. | 168 | 4 | 1 | 5 | 7 |
| ETOH_12% (45).168 | 12% ETOH | 45° C. | 168 | 4 | 2 | 5 | 6 |
| ETOH_12% (45).168 | 12% ETOH | 45° C. | 168 | 6 | 0 | 6 | 7 |
| ETOH_12% (45).168 | 12% ETOH | 45° C. | 168 | 6 | 0 | 5 | 6 |
| ETOH_12% (45).168 | 12% ETOH | 45° C. | 168 | 6 | 0 | 5 | 6 |
| ETOH_12% (45).168 | 12% ETOH | 45° C. | 168 | 8 | 0 | 5 | 6 |
| ETOH_12% (60).72 | 12% ETOH | 60° C. | 72 | 1 | 0 | 3 | 6 |
| ETOH_12% (60).72 | 12% ETOH | 60° C. | 72 | 2 | 1 | 5 | 6 |
| ETOH_12% (60).72 | 12% ETOH | 60° C. | 72 | 2 | 0 | 6 | 7 |
| ETOH_12% (60).72 | 12% ETOH | 60° C. | 72 | 0 | 0 | 3 | 4 |
| ETOH_12% (60).72 | 12% ETOH | 60° C. | 72 | 0 | 0 | 2 | 3 |
| ETOH_12% (60).72 | 12% ETOH | 60° C. | 72 | 2 | 2 | 5 | 7 |
| ETOH_12% (60).72 | 12% ETOH | 60° C. | 72 | 2 | 0 | 3 | 6 |
| ETOH_12% (60).72 | 12% ETOH | 60° C. | 72 | 3 | 0 | 2 | 5 |
| ETOH_12% (60).72 | 12% ETOH | 60° C. | 72 | 3 | 0 | 2 | 5 |
| ETOH_12% (60).168 | 12% ETOH | 60° C. | 168 | 0 | 2 | 3 | 6 |
| ETOH_12% (60).168 | 12% ETOH | 60° C. | 168 | 0 | 0 | 3 | 6 |
| ETOH_12% (60).168 | 12% ETOH | 60° C. | 168 | 1 | 0 | 2 | 5 |
| ETOH_12% (60).168 | 12% ETOH | 60° C. | 168 | 2 | 0 | 1 | 2 |
| ETOH_12% (60).168 | 12% ETOH | 60° C. | 168 | 2 | 0 | 3 | 4 |
| ETOH_12% (60).168 | 12% ETOH | 60° C. | 168 | 2 | 0 | 2 | 3 |
| ETOH_12% (60).168 | 12% ETOH | 60° C. | 168 | 0 | 1 | 3 | 6 |
| ETOH_12% (60).168 | 12% ETOH | 60° C. | 168 | 0 | 0 | 1 | 0 |
| ETOH_12% (60).168 | 12% ETOH | 60° C. | 168 | 0 | 0 | 0 | 0 |
| ETOH_7% (25).72 | 7% ETOH | 25° C. | 72 | 4 | 0 | 7 | 9 |
| ETOH_7% (25).72 | 7% ETOH | 25° C. | 72 | 5 | 0 | 8 | 9 |
| ETOH_7% (25).72 | 7% ETOH | 25° C. | 72 | 6 | 1 | 7 | 8 |
| ETOH_7% (25).72 | 7% ETOH | 25° C. | 72 | 4 | 0 | 7 | 8 |
| ETOH_7% (25).72 | 7% ETOH | 25° C. | 72 | 6 | 0 | 6 | 7 |
| ETOH_7% (25).72 | 7% ETOH | 25° C. | 72 | 6 | 0 | 5 | 6 |
| ETOH_7% (25).72 | 7% ETOH | 25° C. | 72 | 6 | 1 | 6 | 7 |
| ETOH_7% (25).72 | 7% ETOH | 25° C. | 72 | 7 | 0 | 6 | 7 |
| ETOH_7% (25).72 | 7% ETOH | 25° C. | 72 | 7 | 0 | 6 | 7 |
| ETOH_7% (25).168 | 7% ETOH | 25° C. | 168 | 3 | 0 | 7 | 8 |
| ETOH_7% (25).168 | 7% ETOH | 25° C. | 168 | 4 | 0 | 8 | 10 |
| ETOH_7% (25).168 | 7% ETOH | 25° C. | 168 | 5 | 3 | 7 | 7 |
| ETOH_7% (25).168 | 7% ETOH | 25° C. | 168 | 6 | 0 | 6 | 9 |
| ETOH_7% (25).168 | 7% ETOH | 25° C. | 168 | 6 | 1 | 8 | 9 |
| ETOH_7% (25).168 | 7% ETOH | 25° C. | 168 | 6 | 0 | 6 | 8 |
| ETOH_7% (25).168 | 7% ETOH | 25° C. | 168 | 4 | 0 | 7 | 7 |
| ETOH_7% (25).168 | 7% ETOH | 25° C. | 168 | 4 | 0 | 7 | 10 |
| ETOH_7% (25).168 | 7% ETOH | 25° C. | 168 | 7 | 1 | 5 | 7 |
| ETOH_7% (45).72 | 7% ETOH | 45° C. | 72 | 4 | 0 | 6 | 8 |
| ETOH_7% (45).72 | 7% ETOH | 45° C. | 72 | 5 | 2 | 5 | 7 |
| ETOH_7% (45).72 | 7% ETOH | 45° C. | 72 | 5 | 0 | 6 | 7 |
| ETOH_7% (45).72 | 7% ETOH | 45° C. | 72 | 4 | 0 | 6 | 9 |
| ETOH_7% (45).72 | 7% ETOH | 45° C. | 72 | 5 | 1 | 6 | 8 |
| ETOH_7% (45).72 | 7% ETOH | 45° C. | 72 | 6 | 2 | 6 | 8 |
| ETOH_7% (45).72 | 7% ETOH | 45° C. | 72 | 4 | 0 | 7 | 9 |
| ETOH_7% (45).72 | 7% ETOH | 45° C. | 72 | 6 | 1 | 6 | 6 |
| ETOH_7% (45).72 | 7% ETOH | 45° C. | 72 | 6 | 0 | 6 | 6 |
| ETOH_7% (45).168 | 7% ETOH | 45° C. | 168 | 4 | 3 | 5 | 8 |
| ETOH_7% (45).168 | 7% ETOH | 45° C. | 168 | 5 | 2 | 6 | 8 |
| ETOH_7% (45).168 | 7% ETOH | 45° C. | 168 | 6 | 1 | 5 | 6 |
| ETOH_7% (45).168 | 7% ETOH | 45° C. | 168 | 4 | 3 | 5 | 7 |
| ETOH_7% (45).168 | 7% ETOH | 45° C. | 168 | 5 | 2 | 5 | 7 |
| ETOH_7% (45).168 | 7% ETOH | 45° C. | 168 | 5 | 1 | 5 | 7 |
| ETOH_7% (45).168 | 7% ETOH | 45° C. | 168 | 3 | 2 | 5 | 8 |
| ETOH_7% (45).168 | 7% ETOH | 45° C. | 168 | 4 | 1 | 6 | 8 |
| ETOH_7% (45).168 | 7% ETOH | 45° C. | 168 | 5 | 2 | 4 | 6 |
| ETOH_7% (60).72 | 7% ETOH | 60° C. | 72 | 0 | 0 | 2 | 4 |
| ETOH_7% (60).72 | 7% ETOH | 60° C. | 72 | 0 | 0 | 2 | 3 |
| ETOH_7% (60).72 | 7% ETOH | 60° C. | 72 | 1 | 0 | 3 | 4 |
| ETOH_7% (60).72 | 7% ETOH | 60° C. | 72 | 3 | 0 | 5 | 7 |
| ETOH_7% (60).72 | 7% ETOH | 60° C. | 72 | 3 | 0 | 4 | 6 |
| ETOH_7% (60).72 | 7% ETOH | 60° C. | 72 | 5 | 0 | 6 | 7 |
| ETOH_7% (60).72 | 7% ETOH | 60° C. | 72 | 0 | 0 | 1 | 0 |
| ETOH_7% (60).72 | 7% ETOH | 60° C. | 72 | 0 | 1 | 3 | 4 |
| ETOH_7% (60).72 | 7% ETOH | 60° C. | 72 | 1 | 1 | 3 | 4 |
| ETOH_7% (60).168 | 7% ETOH | 60° C. | 168 | 0 | 0 | 2 | 4 |
| ETOH_7% (60).168 | 7% ETOH | 60° C. | 168 | 0 | 0 | 1 | 1 |
| ETOH_7% (60).168 | 7% ETOH | 60° C. | 168 | 2 | 0 | 2 | 4 |
| ETOH_7% (60).168 | 7% ETOH | 60° C. | 168 | 0 | 0 | 3 | 2 |
| ETOH_7% (60).168 | 7% ETOH | 60° C. | 168 | 0 | 0 | 2 | 5 |
| ETOH_7% (60).168 | 7% ETOH | 60° C. | 168 | 1 | 0 | 2 | 2 |
| ETOH_7% (60).168 | 7% ETOH | 60° C. | 168 | 0 | 0 | 2 | 3 |
| ETOH_7% (60).168 | 7% ETOH | 60° C. | 168 | 0 | 0 | 0 | 2 |
| ETOH_7% (60).168 | 7% ETOH | 60° C. | 168 | 2 | 0 | 1 | 3 |
| C.ontrol_72 | C.ontrol | MI | 72 | 5 | 3 | 7 | 8 |
| C.ontrol_72 | C.ontrol | MI | 72 | 6 | 1 | 5 | 9 |
| C.ontrol_72 | C.ontrol | MI | 72 | 6 | 2 | 6 | 7 |
| C.ontrol_72 | C.ontrol | MI | 72 | 4 | 2 | 7 | 9 |
| C.ontrol_72 | C.ontrol | MI | 72 | 6 | 0 | 7 | 9 |
| C.ontrol_72 | C.ontrol | MI | 72 | 7 | 0 | 6 | 9 |
| C.ontrol_72 | C.ontrol | MI | 72 | 3 | 0 | 6 | 9 |
| C.ontrol_72 | C.ontrol | MI | 72 | 3 | 0 | 8 | 10 |
| C.ontrol_72 | C.ontrol | MI | 72 | 6 | 0 | 8 | 8 |
| C.ontrol_168 | C.ontrol | MI | 168 | 3 | 3 | 6 | 7 |
| C.ontrol_168 | C.ontrol | MI | 168 | 5 | 3 | 6 | 7 |
| C.ontrol_168 | C.ontrol | MI | 168 | 7 | 2 | 5 | 6 |
| C.ontrol_168 | C.ontrol | MI | 168 | 4 | 4 | 6 | 6 |
| C.ontrol_168 | C.ontrol | MI | 168 | 5 | 2 | 5 | 7 |
| C.ontrol_168 | C.ontrol | MI | 168 | 5 | 3 | 4 | 7 |
| C.ontrol_168 | C.ontrol | MI | 168 | 3 | 4 | 5 | 7 |
| C.ontrol_168 | C.ontrol | MI | 168 | 4 | 2 | 6 | 8 |
| C.ontrol_168 | C.ontrol | MI | 168 | 5 | 4 | 5 | 8 |

EXAMPLE 2

### Evaluation of Temperature of the Development of Cocoa Flavor

To further evaluate the effect of temperature on the development of flavor, cocoa beans from three clones (PS1319, TSH 1188 and CCN 51) were soaked in a12% (v/v) ethanol solution. Six temperatures were evaluated: 45° C., 48° C., 51° C., 54° C., 57° C. and 60° C. Approximately 600 g of de-pulped cocoa beans were used per treatment. A sufficient amount of ethanol was used to completely cover the beans.

Samples were collected at 72 hours and the beans were processed into cocoa liquor and assessed for flavor. The flavor profile of the chocolate liquor produced as tasted by a professional taster in a double blind taste test.

### EXAMPLE 3

### Determination of the Optimal Temperature for the Development of Cocoa Flavor

To further evaluate the effect of temperature on the development of flavor, cocoa beans from multiple clones (e.g., PS1319, TSH 1188 and CCN 51) will be soaked in a single concentration of ethanol (e.g. 7%, 12% (v/v)) solution for a set time such as for example 72 hrs. Multiple temperatures will be evaluated: 30° C., 33° C., 36° C., 39° C., 41° C., 44° C. In addition one or more of the temperatures described in Example 2 will be used (e.g., 45° C., 48° C., and 60° C.). Approximately 600 g of de-pulped cocoa beans are used per treatment. A sufficient amount of ethanol is used to completely cover the beans.

Samples are collected at 72 hours and the beans are processed into cocoa liquor and assessed for flavor. The flavor profile of the chocolate liquor produced will be determined by a professional taster in a double blind taste test.

EXAMPLE 4

### Determination of the Optimal Ethanol Concentration for the Development of Cocoa Flavor

To further evaluate the effect of ethanol concentration on the development of flavor, cocoa beans from multiple clones (e.g., PS1319, TSH 1188 and CCN 51) will be soaked in multiple concentration of ethanol (e.g. 2%, 3%, 5%, 7%, 12%, 15%, 20% or 25% (v/v) ethanol solution for a set time such as for example 72 hrs at the optimal temperature determined in Example 3. Approximately 600 g of de-pulped cocoa beans are used per treatment. A sufficient amount of ethanol is used to completely cover the beans.

Samples are collected at 72 hours and the beans are processed into cocoa liquor and assessed for flavor. The flavor profile of the chocolate liquor produced will be determined by a professional taster in a double blind taste test.

EXAMPLE 5

### Determination of the Soak Time for the Development of Cocoa Flavor

To further evaluate the effect of soak time on the development of flavor, cocoa beans from multiple clones (e.g., PS1319, TSH 1188 and CCN 51) will be soaked at the optimal temperature determined in Example 3 and the optimal ethanol concentration determined in Example 4. Approximately 600 g of de-pulped cocoa beans are used per treatment. A sufficient amount of ethanol is used to completely cover the beans.

Samples are collected at multiple times (e.g., 24, 48, 72, 96, 120, 144, or 168 hours and the beans are processed into cocoa liquor and assessed for flavor. The flavor profile of the chocolate liquor produced will be determined by a professional taster in a double blind taste test.

One skilled in the art will appreciate that experiments described in Example 3-5 may be performed in a different order or even as a single integrated experiment (eg: partial or full factorial) to determine the optimal time, temperature, and ethanol concentration for the development of the best cocoa flavor.

1. A method of processing fruit seeds comprising:
a. adding unfermented fruit seeds to a first solution of a defined concentration of ethanol wherein said defined concentration is from about 1% to about 16% (v/v) in a volume sufficient to cover the fruit seeds;
b. maintaining the first solution at a first set temperature that is less than 55° C. for a first period of between 24 to 96 hours wherein the solution remains substantially free of microbial growth; and
c. removing the fruit seeds from the solution thereby producing processed fruit seeds.

2. The method of claim 1, further comprising prior to step (c) transferring the fruit seeds to a second solution of a defined concentration of ethanol wherein said defined concentration is from about 1% to 16% (v/v) in a volume sufficient to cover the fruit seeds and maintaining the solution at a second set temperature that is less than 55° C. for a first period of between 24 to 96 hours wherein the solution remains substantially free of microbial growth.

3. The method of claim 1, further comprising prior to step (c) maintaining the first solution at a second set temperature that is less than 55° C. for a second period of between wherein the solution remains substantially free of microbial growth.

4. The method of claim 1, wherein the fruit seeds are in a bulk quantity.

5-6. (canceled)

7. The method of claim 1, wherein the fruit seeds are substantially de-pulped prior to step (a).

8. The method of claim 1, further comprising, adding pulp to the solution prior to step (b), wherein the pulp has been treated such that endogenous microbial activity is inhibited.

9. The method of claim 8, wherein the pulp has been mechanically processed.

10-11. (canceled)

12. The method of claim 1, wherein the fruit seeds have been mechanically or physically processed prior to step (a).

13-15. (canceled)

16. The method of claim 1, wherein the fruit seeds are dried until the total moisture content is about 25-50% prior to step (a).

17-19. (canceled)

20. The method of claim 1, wherein the solution contains about 0.001 mg to 12 mg citric acid per gram of ethanol solution.

21. The method of claim 1, wherein the solution contains about 1.0 mg to 5 mg acetic acid per gram of ethanol solution.

22. The method of claim 1, wherein the method further comprises the step of:
drying the processed fruit seeds until the total moisture content is about 5 to 10 percent to produce dried fruit seeds.

23. The method of claim 22, wherein the method further comprises roasting the dried fruit seeds to produce roasted fruit seeds.

24. The method of claim 22, wherein the fruit seeds are cocoa beans and the method further comprises removing the shell and recovering the cocoa nibs.

25. The method of claim 24, wherein the cocoa nibs are milled to produce cocoa liquor.

26. The method of claim 1, wherein the ethanol concentration is 7% or 12% (v/v).

27. The method of claim 1, wherein the temperature is between about 25° C. to 55° C.

28. The method of claim 1, wherein the temperature is between about 45° C. to 51° C.

29. The method of claim 1, wherein the processed fruit seeds have a titratable acidity of less than 1.0 mL 0.1N NaOH per gram of processed fruit seeds.

30. The method of claim 1, wherein the fruit seeds are cocoa beans or cupuacu beans.

31-36. (canceled)
